(19) United States
(12) Patent Application Publication
(10) Pub. No.: US 2015/0081522 A1
(43) Pub. Date: Mar. 19, 2015

(54) SYSTEM AND METHOD FOR AUTOMATICALLY PROVIDING A/R-BASED LINES OF CREDIT TO BUSINESSES

(71) Applicant: Fundbox, Ltd., Tel Aviv (IL)

(72) Inventors: Eyal Shinar, Tel Aviv (IL); Yuval Ariav, Tel Aviv (IL); Tomer Michaeli, Herzliya (IL)

(21) Appl. No.: 14/448,530

(22) Filed: Jul. 31, 2014

Related U.S. Application Data
(60) Provisional application No. 61/860,931, filed on Aug. 1, 2013.

(51) Int. Cl. G06Q 40/02

(52) U.S. Cl. CPC G06Q 40/025
USPC 705/38

(57) ABSTRACT

A method and system for providing liquid funds to a business, the method comprising the business issuing an accounts receivable (AR) invoice to a client, the AR invoice requesting payment of a total amount charged, the business registering with a funder for an automatically underwritten fund provision service, the business requesting liquid funds from the funder, the liquid funds having a value determined by the total amount charged on the AR invoice, and the business receiving requested liquid funds from the funder.

### CROSS REFERENCE TO RELATED APPLICATION

This application claims the priority of U.S. Provisional Application No. 61/860,931 entitled “SYSTEM AND METHOD FOR AUTOMATICALLY PROVIDING A/R-BASED LINES OF CREDIT TO BUSINESSES,” filed on Aug. 1, 2013, the disclosure of which is hereby incorporated by reference in its entirety.

### BACKGROUND OF THE INVENTION

The invention described herein generally relates to automatically providing liquid funds to businesses. In particular, the disclosure relates to the risk associated with underwriting liquid funds provided against accounts receivable (AR) invoices.

Many businesses, particularly small businesses, are often vulnerable to cash flow volatility. Consequently, small businesses often need to maintain a high DDA (demand deposit accounts) balance to serve as a buffer in order to meet payroll, tax or other commitments during a period of low receipts. This buffer can be very important when needed but at other times is unnecessary and wasteful.

The need to maintain such a buffer ties up cash which may otherwise be useful to the running of the business, many business nevertheless consider it necessary to maintain the buffer as banks do not readily provide a standby line of credit when required.

At the same time, the traditional small business lending model used by banks has not been particularly profitable, with small business loan portfolios typically showing positive accounting profits but negative economic profits through the cycle. As a result, banks have experimented with various approaches to small business lending. Some methods have used credit scores of the business, its owner or both as key inputs in semi-automated systems similar to those used for personal or consumer loans. Nevertheless, this consumer-like approach has not succeeded in reducing costs for the lender as relatively few loan applications can be decided automatically. In part this is because available data on small businesses has not been as robust and predictive as in the consumer sphere and therefore credit scores are not easily transferred from the consumer sphere to the business sphere.

Indeed, though computers have been used by lenders in the process of evaluating loan applications, their use has been inefficient and non-optimal due, in part, to the unavailability or incompleteness of the information. This has therefore required ongoing input by human beings in evaluating applications, which makes the process prone to subjectivity and error. Moreover, human input in collecting the necessary information similarly leads to judgment errors and inconsistent results.

There is therefore a need for a system for providing lines of credit to small businesses and for underwriting provision of liquid funds. There is a further need for a computerized system which operates in an improved and significantly more efficient manner, and which makes key information stored on databases in disparate systems available to be collected and processed in an automated fashion to provide consistency in the results and reduce the subjectivity and misjudgments associated with human activity. The present disclosure addresses this need.

### SUMMARY OF THE INVENTION

It is one aspect of the disclosure to teach a method for enabling qualified businesses to obtain lines of credit as required through the provision of liquid funds, such as advances, credit, interchange, fees, factoring, loans, investments, purchases, gifts, subsidies or the like. In some embodiments, businesses may qualify for the liquid funds according to the quality of the business's client or vendor network. Optionally, liquid funds may be associated with, determined by or underwritten by accounts receivable (AR) invoices issued by the business to clients.

It is an aspect of the disclosure to teach a method for providing liquid funds to a business may comprise: the business issuing an accounts receivable (AR) invoice to a client, the AR invoice requesting payment of a total amount charged; the business registering with a funder for an automatically underwritten fund provision service; the business requesting liquid funds from the funder, the liquid funds having a value determined by the total amount charged on the AR invoice; and the business receiving requested liquid funds from the funder.

Where appropriate, the step of the business requesting liquid funds from a funder may comprise: the business accessing an AR invoice based dashboard; the business selecting at least one AR invoice from a list presented by the dashboard; and the business requesting clearance of selected AR invoice. The method may further comprise: the business receiving a suggested payment schedule for the repayment of requested liquid funds. Optionally, the business may edit the suggested payment schedule for the repayment of the requested liquid funds. Accordingly, the business may confirm request of the liquid funds and, if required, may provide the business bank details to the funder.

Typically, the business may further repay the requested liquid funds according to an agreed payment schedule. Optionally, the business may additionally pay a clearing fee to the funder. Notably, where appropriate, embodiments of the systems and methods disclosed herein may enable: the business repaying the requested liquid funds earlier than the agreed payment schedule; and the business paying a reduced clearing fee.

Furthermore, in certain embodiments, the method for providing liquid funds may further comprise the funder assessing the credit worthiness of the business.

According to some embodiments, the method may comprise: the business providing the funder with access to digital data from business management software; and the business receiving at least one credit limit determined by the digital data. For example, such business management software may comprises at least one of the group consisting of: financial management software, accounting software, invoicing software, Customer Relationship Management (CRM), payroll software, e-invoicing software and the like as well as combinations thereof.

Optionally, the at least one credit limit may be selected from at least one of the group consisting of: a maximum total funds available to the business from the funder; a maximum value of total amount charged on a single AR invoice which is available to the business from the funder; a maximum value of funds owed to the business by a single client which are available to the business from the funder, or the like as required.

Optionally, the method includes the funder obtaining secondary digital data pertaining to the business from at least one secondary source. Such secondary digital data may comprise data pertaining to the quality of the clients or the vendors of the business. For example, the secondary source comprises at least one of a group consisting of: social networks, public records, government records, legal records, newspaper archives, data aggregators and the like as well as combinations thereof.

Where appropriate, the method may include the business accessing an AR invoice based dashboard. Optionally, the AR invoice based dashboard presents a list of AR invoices issued by the business. The list of AR invoices may be generated from digital data accessed from business management software, such as from a database associated with accounting software, invoicing software, e-invoicing software or the like

Variously, the AR invoice based dashboard presents, for each AR invoice, at least one characteristic selected from: amount charged, issue date, estimated payment date, availability status and combinations thereof. Additionally or alternatively, the AR invoice based dashboard provides information relating to credit available to the business. Further optionally, the dashboard may provide a request facility whereby the business may select at least one AR invoice and request liquid funds having value determined by the amount charged on selected AR invoice.

It is according to other aspects of the disclosure to teach a computer implemented method for providing liquid funds to a business comprising at least one processor executing instructions to perform the following operations: receiving a request from the business for liquid funds having a value determined by the total amount charged on an accounts receivable (AR) invoice issued to a client by the business; assessing credit worthiness of the business; and authorizing transfer of requested funds to the business.

Optionally, the operation of receiving a request from the business comprises: presenting an AR invoice based dashboard to the business; receiving a request for clearance of at least one AR invoice selected by the business from a list presented by the dashboard.

Alternatively, or additionally, the operation of receiving a request from the business further comprises: suggesting a payment schedule to the business for the repayment of requested liquid funds. Optionally, the operation of receiving a request from the business further comprises: receiving an edited suggested payment schedule for the repayment of the requested liquid funds; and approving the edited suggested payment schedule.

Accordingly, the method may further comprise receiving bank details from the business. Furthermore, the method may comprise receiving repayment of the requested liquid funds according to an agreed payment schedule. Optionally, the method further includes receiving a clearing fee from the business. Where appropriate, the method may further include offering a reduced clearing fee for early repayment.

It is according to still another aspect of the disclosure to teach a computer implemented method for providing a credit rating for a business, the method comprising at least one processor executing instructions to perform the following operations: determining a credit rating function; obtaining access to digital data from a business management software used by the business; identifying at least one risk indicator from the digital data; using the at least one risk indicator as an argument of the credit rating function; and applying the credit rating function thereby generating a credit rating for the business. Optionally, the method further includes the at least one processor executing instructions to perform the additional operations: obtaining secondary digital data pertaining to the business from secondary sources; identifying at least one secondary risk indicator from the digital data; and using the at least one secondary risk indicator as an argument for the credit rating function.

Optionally, the credit rating function comprises at least one monomial factor comprising the product of at least one risk indicator parameter and a weighting coefficient.

It is yet another aspect of the current disclosure to introduce a system for providing liquid funds to a business comprising at least one funder server in communication with a communication network, the communication network comprising at least one business terminal, and at least one business management database storing digital data pertaining to business interactions of the business, wherein the funder server is operable to: receive from the business terminal requests for liquid funds; access the business management database and to obtain the digital data; assess credit worthiness of the business according to the digital data; and authorize transfer of requested funds to the business. Optionally, the communication network further comprises at least one secondary data source and the funder server is further operable to access the at least one secondary source and to obtain the secondary data pertaining to the business.

Where appropriate, the funder server comprises at least one processor operable to execute instructions to perform the following operations: determining a credit rating function; identifying at least one risk indicator from the digital data; using the at least one risk indicator as an argument of the credit rating function; and applying the credit rating function thereby generating at least one credit rating for the business.

According to one embodiment, a distributed system of computerized devices connected over a communication network is provided. The distributed system is useable to provide liquid funds to an entity and comprises one or more computerized terminals connected to the communication network and programmed to send over the communication network registration data and one or more requests for liquid funds computed as a function of an amount charged on an accounts receivable invoice issued by the entity, a computerized storage facility accessible over the communication network and storing an entity management database used by the entity and containing first digital data related to transactions of the entity, and a funder server connected to the communication network and programmed to receive the registration data and the one or more requests for liquid funds from the one or more computerized terminals, to verify the registration data, to retrieve the first digital data from the entity management database based on the verified registration data, to assess a credit worthiness of the entity and/or a rating of the accounts receivable invoices based at least in part on the first digital data, to determine whether to generate and transmit an electronic instruction to transfer to the entity some or all of the liquid funds identified in the one or more requests, and, based on such determination, to transmit the electronic instruction to a funder computing system connected over the communication network.

One embodiment includes wherein the communication network is the Internet. Optionally, the one or more computerized terminals may comprise at least one selected from the group consisting of: desktop computers, laptop computers, mobile phones, and tablet computers.

Where appropriate, the entity management database comprises at least one of the group consisting of: financial management software, accounting software, invoicing software, Customer Relationship Management (CRM), payroll software project management software, HR management software, time-tracking software, and combinations thereof.

In another embodiment, the one or more computerized terminals may be programmed to generate a user interface displaying an accounts receivable invoice based dashboard from which a user may select the accounts receivable invoice upon which the request for liquid funds is based. Furthermore, the user interface may provide a request facility whereby the user may select the accounts receivable invoice and generate the request for liquid funds based on the selected accounts receivable invoice.

The system may further comprise a memory device in or accessible to the funder server storing second digital data pertaining to the entity obtained from at least one secondary source accessible over the communication network. In a further embodiment, the secondary source comprises at least one of a group consisting of: social networks, computerized public records, computerized government records, computerized legal records, computerized newspaper archives, computerized data aggregators, and combinations thereof.

According to another embodiment, in a system comprising at least one funder server in communication with a communication network, the communication network being connected to at least one computerized terminal, a first storage device storing an entity management database storing first digital data pertaining to transactions of an entity, and a second storage device not managed by said entity and storing second digital data pertaining to said entity, a method of operating said funder server to provide liquid funds to the entity in an improved manner is provided. The method comprising receiving over the communication network from said computerized terminal a request for liquid funds a registration data identifying said entity, accessing said first storage device over said communication network and retrieving said first digital data from said entity management database based on said registration data, accessing said second storage device over said communication network and retrieving said second digital data based on said registration data, computing a credit rating value of the entity based at least in part on said first or second digital data by automatically identifying risk indicators in the first or second digital data, applying a weighting coefficient to each risk indicator, and applying a credit rating function to said weighted risk indicators to compute the credit rating value, automatically determining whether to authorize transfer of the requested liquid funds to the entity based at least in part on said credit rating value.

The funder server may further compute the credit rating value using a credit rating function of

$$R = {K}_{f} \frac{\sum {W}_{i} {F}_{i}}{{N}_{f}} + {K}_{s} \frac{\sum {W}_{j} {S}_{j}}{{N}_{s}}$$

where R represents the credit rating value to be computed, Fi represents a risk indicator identified in the first digital data, Wi represents the weighting coefficient of Fi, Nf represents the number of risk indicators identified in the first digital data, Kf represents a weighting factor for the risk contribution from the first digital data, Fj represents a risk indicator identified in second digital data, Wj represents the weighting coefficient of Fj, Ns represents the number of risk indicators identified in the second digital data, and Ks represents a weighting factor for the risk contribution from the secondary data.

It is noted that in order to implement the methods or systems of the disclosure, various tasks may be performed or completed manually, automatically, or combinations thereof. Moreover, according to selected instrumentation and equipment of particular embodiments of the methods or systems of the disclosure, some tasks may be implemented by hardware, software, firmware or combinations thereof using an operating system. For example, hardware may be implemented as a chip or a circuit such as an ASIC, integrated circuit or the like. As software, selected tasks according to embodiments of the disclosure may be implemented as a plurality of software instructions being executed by a computing device using any suitable operating system.

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data. Optionally, a network connection may additionally or alternatively be provided. User interface devices may be provided such as visual displays, audio output devices, tactile outputs and the like. Furthermore, as required user input devices may be provided such as keyboards, cameras, microphones, accelerometers, motion detectors or pointing devices such as mice, roller balls, touch pads, touch sensitive screens or the like.

### BRIEF DESCRIPTION OF THE FIGURES

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1 is a schematic representation of selected elements of a distributed system for providing liquid funds to a business according to the current disclosure;

FIG. 2A is a flowchart representing selected actions of one possible method for a funder to register and assess the credit worthiness of a business;

FIG. 2B is a flowchart representing a possible method for applying a credit rating algorithm to assess credit worthiness of a business;

FIG. 3 is a flowchart representing selected actions of a possible method for a funder to provide funds to a business underwritten by an accounts receivable (AR) invoice;

FIGS. 4A-F schematic representations of possible user interfaces illustrating examples of a registration procedure for a liquid funds provisioning service offered by a funder;

FIG. 5A is a schematic representation of a possible AR invoice based dashboard which may be presented to a business by a funder;

FIG. 5B is a schematic representation of the AR invoice based dashboard illustrating a request mechanism via which a business user may request provision of liquid funds associated with a AR invoice selected from the dashboard;

FIG. 5C is a schematic representation of the AR invoice based dashboard illustrating a confirmation mechanism via which a business user may confirm the request of the liquid funds and enter bank details, and

FIGS. 6A and 6B schematically illustrate another embodiment presented by an application program running on a mobile phone.

### DETAILED DESCRIPTION

Aspects of the present disclosure relate to systems and methods for providing liquid funds such as business loans, credit, factoring, payments or the like. In particular the disclosure relates to providing liquid funds to businesses that use online business management services. Digital data pertaining to the financial interactions of the business and stored on a business management database, may be made accessible to a funding facility. Accordingly, the funding facility may be able to calculate a credit rating for the business based upon reliable and up-to-date financial data.

Optionally, the systems and methods disclosed herein may provide a mechanism for underwriting business risk for the purpose of credit, advances, interchange, fees, purchases, loans, factoring, forfeiting, payments, investments, gifts, subsidies or other provision of liquid funds, against business assets such as accounts receivable (AR) invoices issued to clients for goods and services provided. Such a system may allow businesses, particularly small businesses, to obtain lines of credit suitable to their operational and financial needs.

It is noted that the systems and methods of the disclosure herein may not be limited in its application to the details of construction and the arrangement of the components or methods set forth in the description or illustrated in the drawings and examples. The systems and methods of the disclosure may be capable of other embodiments or of being practiced or carried out in various ways.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

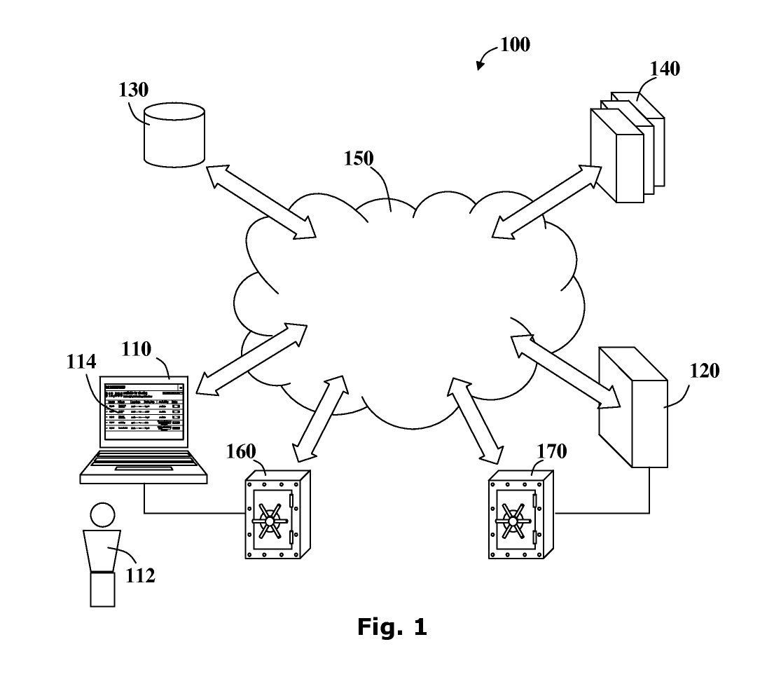

Reference is made to FIG. 1 schematically representing a distributed system 100 for providing liquid funds to a business, according to the current disclosure. The distributed system 100 comprises a business terminal 110, a funder server 120, a business management database 130, secondary data sources 140, a communication network 150, a business bank 160 and a funder bank 170.

It is noted that the business terminal 110 may be operated by a business user 112 authorized to perform financial transactions on behalf of the business. Such a business terminal may include various devices such as computers, tablet computers, mobile phones, smart televisions or the like, typically in communication with a communication network 150 such as the internet.

The business user 112 may use business management services, such as business management application software, online financial management tools or the like which may store financial data pertaining to the business. For example, business management services may be of various types including accounting software, such as offered by QuickBooks, Xero, Sage, SAP Business One, and the like; invoicing software, such as FreshBooks, FinancialForce, Tradeshift, Ariba (SAP), OB10 and the like; Customer Relationship Management (CRM) software; payroll management software and the like.

Accordingly, the business management database 130 may be an online storage facility in communication with the communication network 150 which stores digital data pertaining to the financial interactions of the business.

It is noted that financial data, stored in the business management database 130, is generally protected due to its sensitive and internal nature. Consequently, access permissions to the data are generally only granted to internal authorized persons representing the business such as members of the finance department, accountants, bookkeepers and the like. Access to such sensitive data is not generally granted to external bodies such as banks, lending facilities and the like.

In contradistinction to generally accepted practice, it is a feature of some embodiments of the systems and methods for providing liquid funds to a business disclosed herein that the business may grant access permission to a funding facility such that the funder server 120 can access digital data stored in the financial management database 130, which can be used to establish the credit worthiness of the business. Accordingly, the funding facility may be able to execute an algorithm using a credit rating function to generate a credit rating for the business based upon risk indicators identified in the digital data.

The funder server 120 may include a computer including a processor operable to execute instructions to perform operations directed to the provision of liquid funds to businesses. For example, instructions may be executed for receiving requests from a business, assessing credit worthiness of the business and, if appropriate, authorizing transfer of the requested funds. It is noted that such instructions as described herein may be performed by a data processor, such as a computing platform or distributed computing system for executing a plurality of instructions. Optionally, the data processor includes or accesses a volatile memory for storing the instructions, data or the like. Additionally or alternatively, the data processor may access a non-volatile storage, for example, a magnetic hard-disk, flash-drive, removable media or the like, for storing instructions and/or data. Optionally, a network connection may additionally or alternatively be provided.

Furthermore, in various embodiments, the funder server 120 may be operable to gather secondary data from secondary data sources 140 connected to the communication network 150 and which may serve as additional inputs into the credit rating function.

Based upon the credit rating generated for the business, the funding facility may set credit limits for liquid funds to be offered to the business. It is another feature of the system that business loans or other provision of liquid funds may be secured by assets such as accounts receivable (AR) invoices. Accordingly, the funder may present a list of AR invoices 112 to the business representative 112, for example as an AR invoice based dashboard such as described herein. Using such a service, the business representative 112 may be able to select an AR invoice from the list and request a liquidity, payment, credit or loan secured or not secured thereby. The funder may then instruct its bank 170 to transfer funds to the business's bank account 160 automatically.

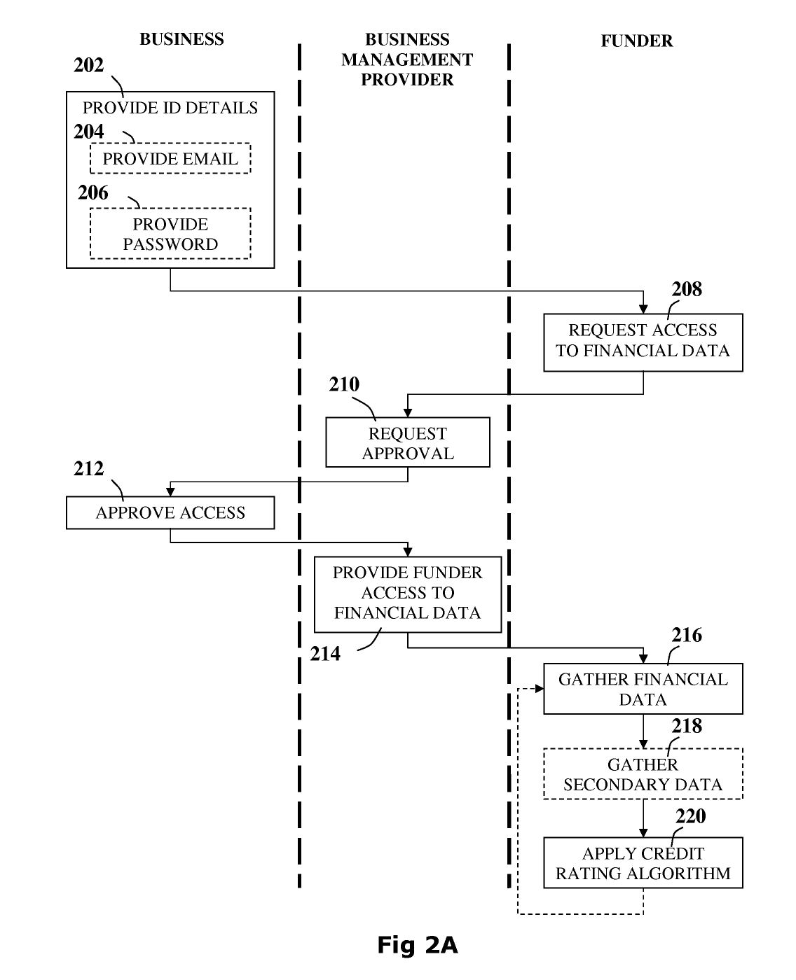

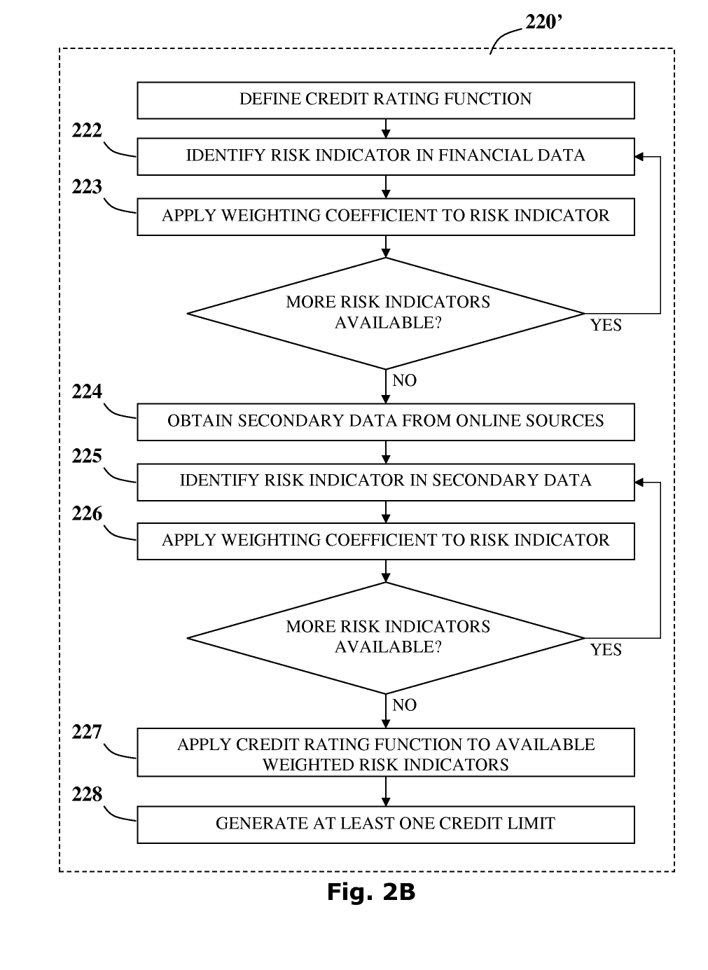

Reference is now made to the flowchart of FIG. 2A representing selected actions illustrating a possible method for a funder to register and assess the credit worthiness of a business. The method includes the business providing identification details 202, the funder requesting access to business or financial data pertaining to the business 208, a third party business management provider requesting approval from the business 210, the business granting access permissions to the funder 212, the third party business management provider providing the funder with access to the business or financial data 214, the funder gathering financial data from the third party business management provider 216, and the funder applying a credit rating algorithm 220 using the gathered business or financial data. Optionally the funder may additionally gather secondary data 218 pertaining to the business and this secondary data may also be used in the credit rating algorithm.

In some embodiments, a business representative may elect to register for a funding service via a software application executed on a communication device such as a computer, mobile telephone, tablet computer, PDA or the like. Additionally or alternatively, the business representative may access a website associated with the funder via a browser or the like. The funder may prompt a business representative to submit identification details, such as a name, username, password, email address, or the like. In a particular the business representative provides an email 204 and defines an access password 206.

Business identification details may be used by the funder to connect with a financial management software used by the business. Accordingly, the funder may request financial data pertaining to the business from the financial management software 208, for example via an application programming interface (API). It is noted that in order to provide access to a new entity such as the funder, the financial management software may request approval from the business representative 210. During the registration process, such requests may take the form of pop ups, alerts or the like presenting a user interface via which the business representative may indicate approval 212 for the third party financial management software to provide financial data to the funder 214. Various financial management software may be accessed such as: accounting software, invoicing software, Customer Relationship Management (CRM), payroll software and the like as well as combinations thereof.

Once access has been provided to the funder, the funder may gather various financial data 216. For example the financial management software may provide data pertaining to business assets such as receivables and the like which may be used to underwrite business loans or other provision of liquid funds.

It is noted that the credit worthiness of the business may depend upon a variety of factors. In addition to the values of business assets it is a feature of embodiments of the current method that the funder may gather information relating to the clients, customers, consumers or the like (collectively termed clients) of the business. Client related information may include data pertaining to quality of the business's client community, for example, the number of clients of the business, the number of active clients, the percentage of business income from each client, the degree of spread of income across clients, the quality of clients, the spread of receivable accounts across clients, and the like. Furthermore, the quality of business assets such as receivables, for example, may be evaluated through knowledge of the clients from whom the receivables are due. Where appropriate business client related data may be gathered from secondary sources such as described herein. Accordingly, the quality of the business's client community may be quantified providing data for assessing a funder's exposure to risk associated with the business. Furthermore, the quality of each business client may be quantified providing more refined data for assessing a funder's exposure to risk associated with a particular receivable asset.

In cases where the funder gathers secondary data 218, the data may relate to various aspects of the business, its network and its clients and vendors. Various public secondary sources are available such as social networks, public records, government records, legal records, newspaper archives, mapping software, blogs, microblogs, reviews and the like as well as combinations thereof. Additionally or alternatively, semi-public secondary sources from which business related data may be accessed include data aggregators, such as Acxicom, ChoicePoint etc., credit reporting agencies, such as Equifax, Cortera, D&B etc., business demographic providers, business intelligence sources and the like.

Accordingly, secondary data relating to the social presence of the business, the owners or the employees of the business, may be gathered from sites such as Facebook, 4Square, LinkedIn, Angie's List, Bazarvoice, Yelp, Yext and the like, or the business's general web presence from sites such as Yellow pages, local newspapers, recruitment sites, review sites and the like. Likewise data may be gathered relating to the social presence and web presence of the clients of the business.

Furthermore, secondary data relating to business's institutional records may be accessed from state records, legal records and the like Likewise data may be gathered relating to the institutional records of the clients of the business.

The financial data and secondary data may be used to provide inputs for a credit rating algorithm which may be applied 220 to generate suitable credit limits for the business.

It is particularly noted that according to embodiments of the methods described herein, the credit rating algorithm is based upon a dynamic data set gathered from financial management databases and web sourced secondary data sources which are themselves updated in an ongoing manner. Accordingly, the data set may be updated regularly in an ongoing fashion such that the credit rating may be recalculated, redetermined or updated as required.

Referring now to the flowchart of FIG. 2B an example of a possible method is represented for applying a credit rating algorithm 220′ to assess credit worthiness of a business. It is noted that the example is presented for illustrative reasons only, other credit rating algorithms may be used as suit requirements.

The credit rating algorithm 220′ of the example includes: defining a credit rating function 221, identifying risk indicators in gathered financial data 122, applying a weighting coefficient to each risk indicator 223, obtaining secondary data from online sources 224, identifying risk indicators in gathered secondary data 122, applying a weighting coefficient to each web sourced risk indicator 223, applying the credit rating function to the available weighted risk indicators 227, and generating at least one credit limit for the business 228. Other algorithms will occur to those skilled in the art.

By way of illustration only, one example of such a risk function may comprise a formula for calculating a credit rating value. The credit rating formula may, for example, comprise a combination of monomials, such as the products of a risk indicator and associated weighting coefficient. An expression for a risk function may take various forms such as the example below:

$$R = {K}_{f} \frac{\sum {W}_{i} {F}_{i}}{{N}_{f}} + {K}_{s} \frac{\sum {W}_{j} {S}_{j}}{{N}_{s}}$$

where R represents the calculated credit rating value, Fᵢ represents a risk indicator identified in financial data, Wᵢ represents the weighting coefficient of Fᵢ, N_{f} represents the number of risk indicators identified in the financial data, K_{f} represents a weighting factor for the risk contribution from the financial data, Fⱼ represents a risk indicator identified in secondary data, Wⱼ represents the weighting coefficient of Fⱼ, Nₛ represents the number of risk indicators identified in the secondary data, and Kₛ represents a weighting factor for the risk contribution from the secondary data.

The credit rating formula above is provided for illustration only and it is appreciated that other formulae or functions for generating credit ratings from gathered data may be alternatively or additionally used to assess the credit worthiness of a business. Indeed the credit rating function may itself be dynamic and may be operable to update itself according to the quantity and nature of the data available for analysis.

Having defined the credit rating function, the data may be analyzed to identify risk indicators in the gathered financial data such as, for example, at least one of: data indicating that the percentage of total accounts receivable associated to a single client exceeds an acceptable threshold, data indicating that a particular asset is a doubtful debt from a client who has a history of non-payment, data indicating that the business has overheads much higher than income for extended periods, and the like as well as combinations thereof.

Likewise, where secondary data is available, further risk indicators may be identified in the gathered secondary data such as, for example, at least one of: data indicating that the business is involved in suspicious or unlawful dealings, that a business client is involved in suspicious or unlawful dealings, that the business has unlisted overheads not indicated in the financial data, the a business client is facing financial difficulties and the like.

For the sake of clarity, one example of secondary data risk indicator generation may include the gathering of information from the advertisements in a local newspaper, say, which indicate that the business regularly employs staff that do not appear in the payroll. By way of another example legal records may indicate that the business, or a business client, is facing an expensive suit and may therefore be unable to meet a payment schedule. Still other examples will occur to those skilled in the art.

Each risk indicators may be assigned a value, say on a scale of 0 to 10, representing the degree of risk they represent. It will be appreciated that the relative importance of each risk indicator is not equal and therefore weighting coefficients may be introduced to combine multiple risk indicators in a harmonious fashion. Weighting coefficients may be predetermined constants or alternatively may be calculated on the fly according to the data available, indeed each weighting coefficient may be generated by a weighting algorithm applied to the data set, possibly in a dynamic manner.

Accordingly, an overall credit rating may be calculated for a business which may be used to generate at least one credit limits, such as the total funds available to the business from the funder; a maximum value of funds due on a single AR invoice available to the business from the funder or the like. Furthermore, credit ratings may be generated which are specific to each business client, for example, a maximum value of funds available to the business from the funder which may be underwritten by an AR invoice due from a particular business client, or the like.

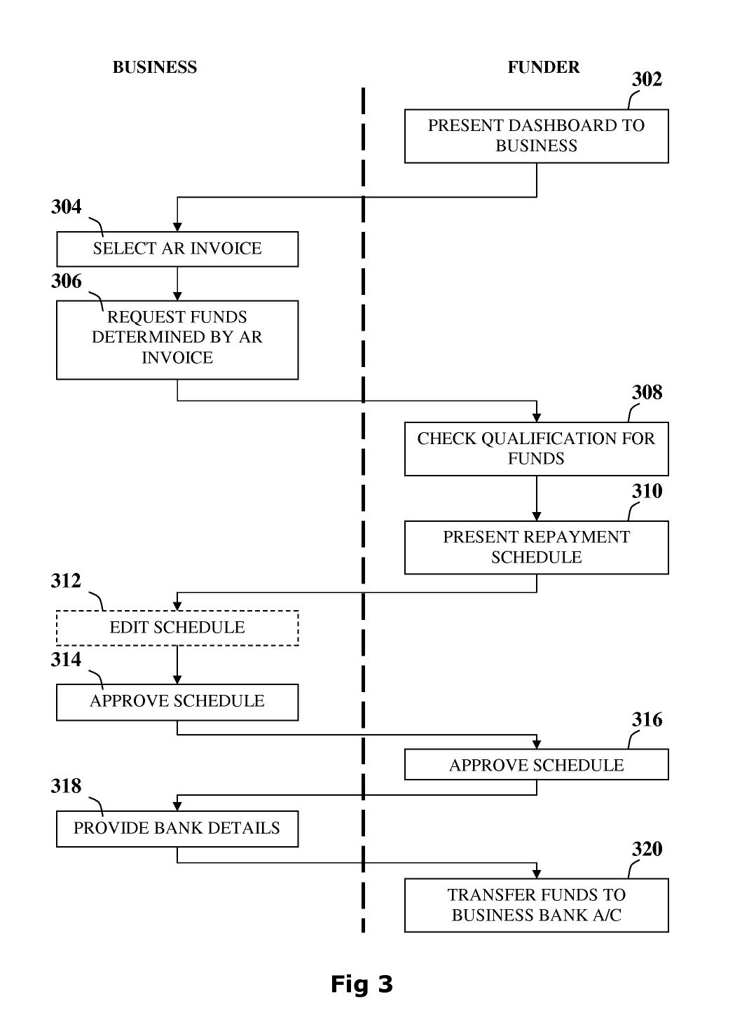

Referring now to the flowchart of FIG. 3 selected actions are represented illustrating a possible method for a funder to provide funds to a business underwritten by an accounts receivable (AR) invoice. The method includes: the funder presenting an AR invoice based dashboard to the business 302; the business selecting an AR invoice 304; the business requesting liquid funds having a value determined by the monies due on the selected AR invoice 306; the funder checking if the business is qualified to receive the requested loan 308; the funder presenting a suggested repayment schedule for the business 310; where appropriate, the business may be permitted to edit the suggested repayment schedule 312. The method may continue with: the business approving the repayment terms 314, the funder approving the repayment terms 316, a business representative providing bank details 318 and the funder instructing their bank to transfer the requested funds to the business's bank account 320.

Accordingly, a business which issues an accounts receivable (AR) invoice to a client, requesting payment of funds due from the client according to certain payment terms, may be enabled to request liquid funds from the funder, having a value equal to or less than the funds due associated with the AR invoice. Upon receipt of such a request from an approved business, the funder may be able to transfer to the business the requested money.

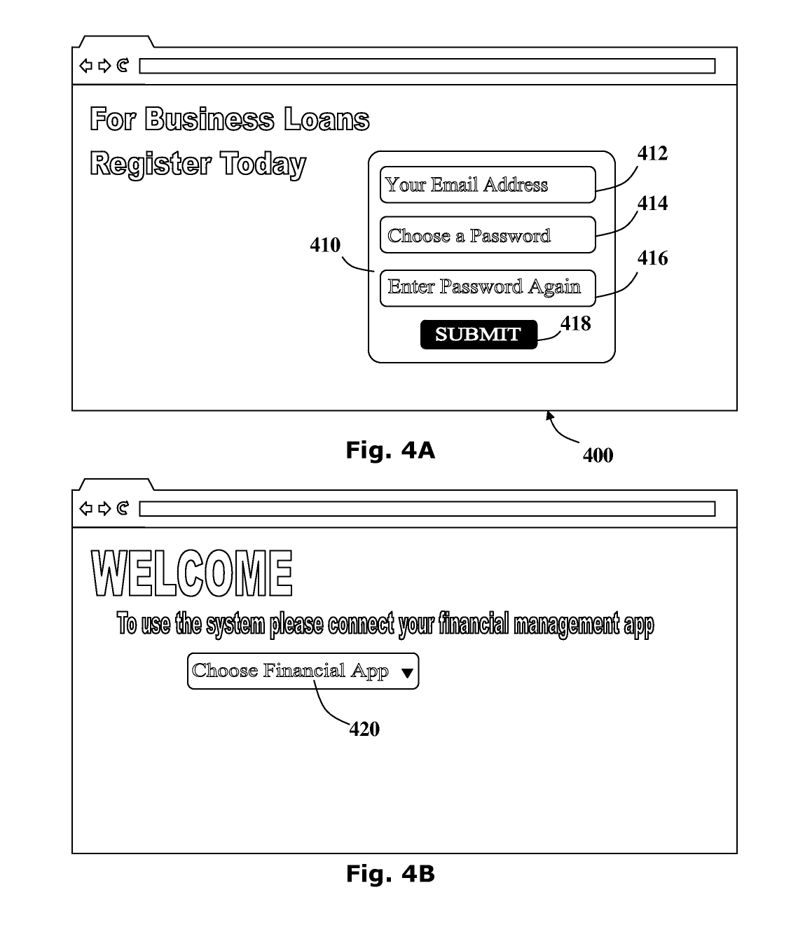

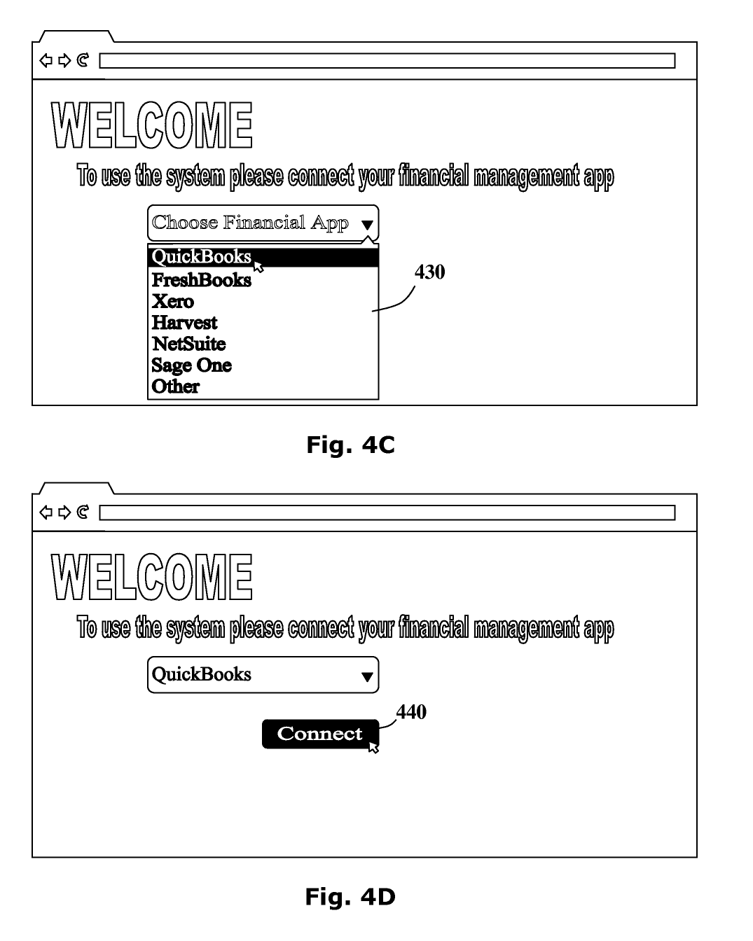

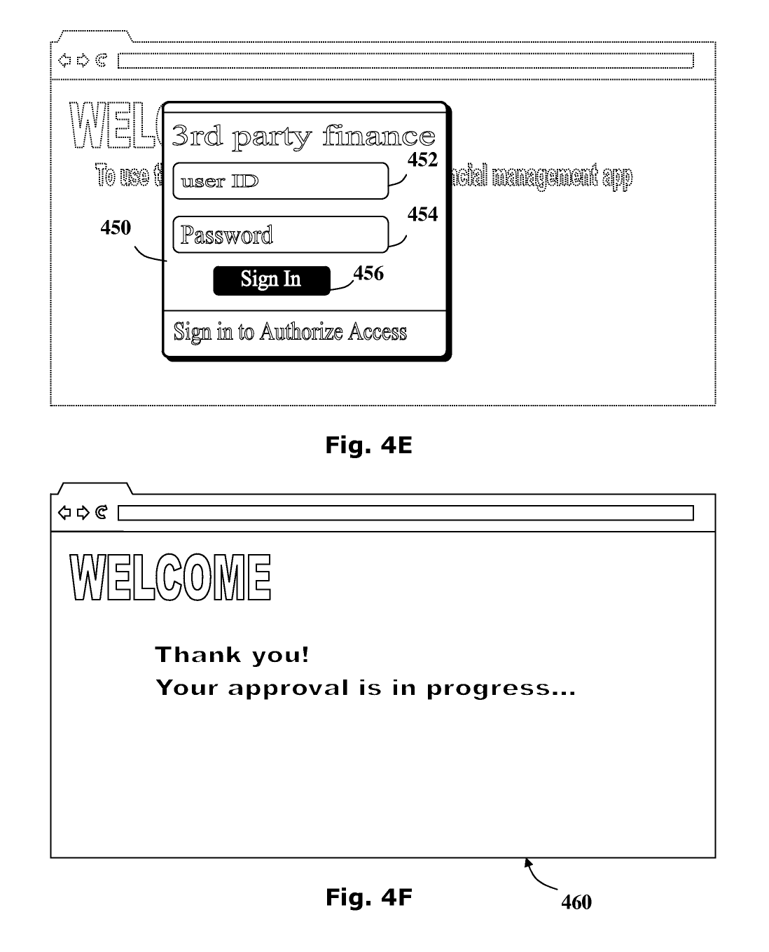

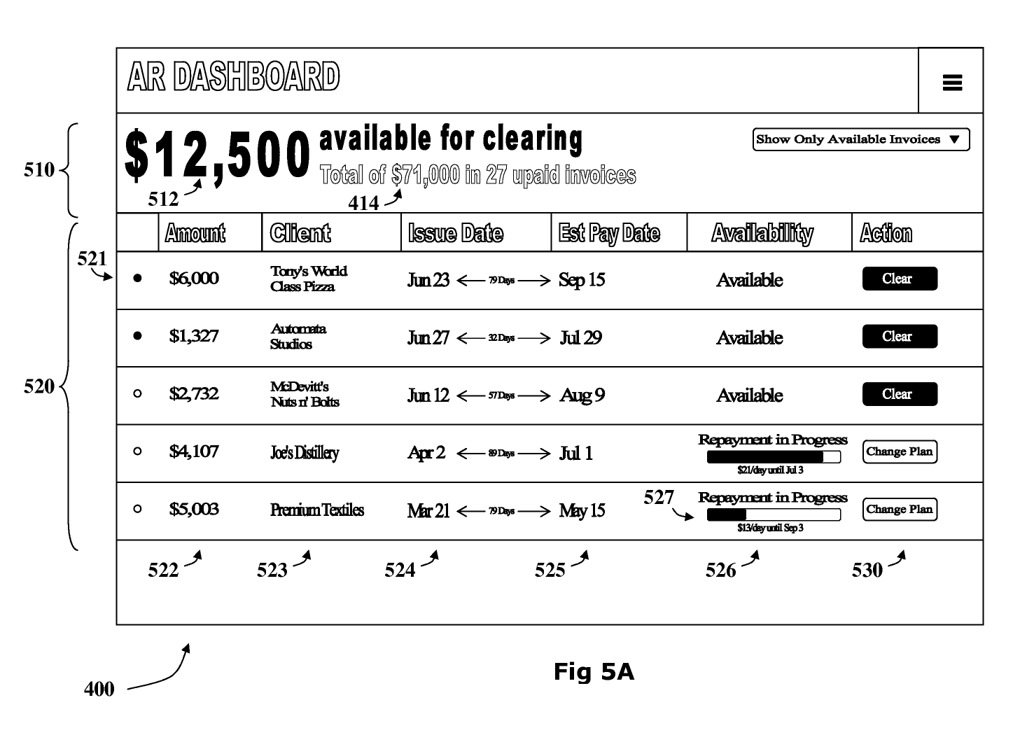

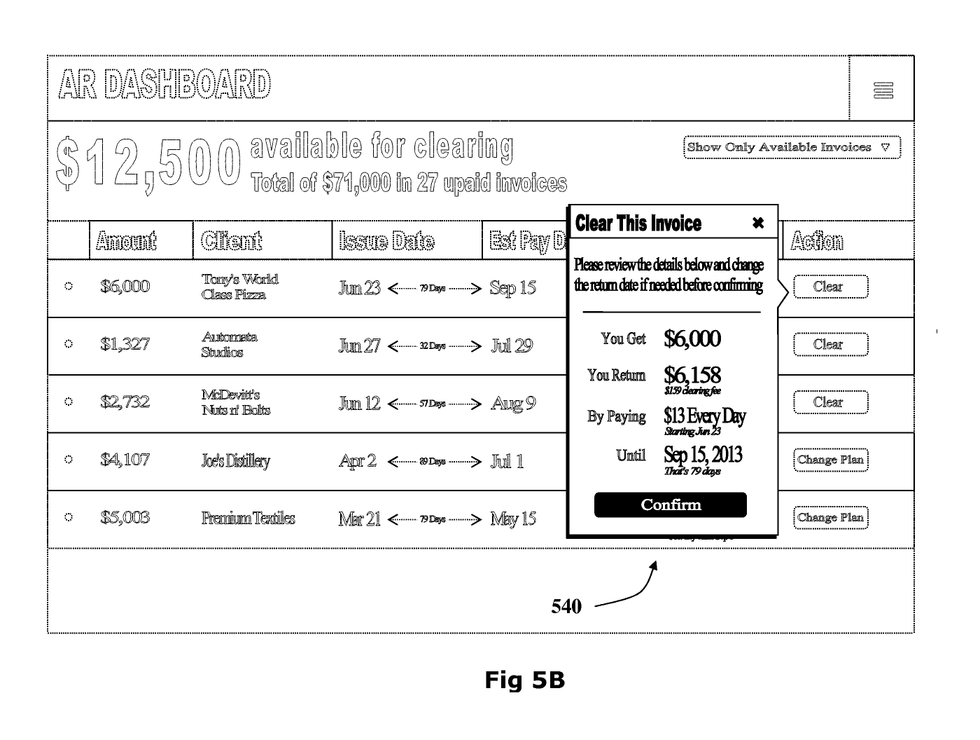

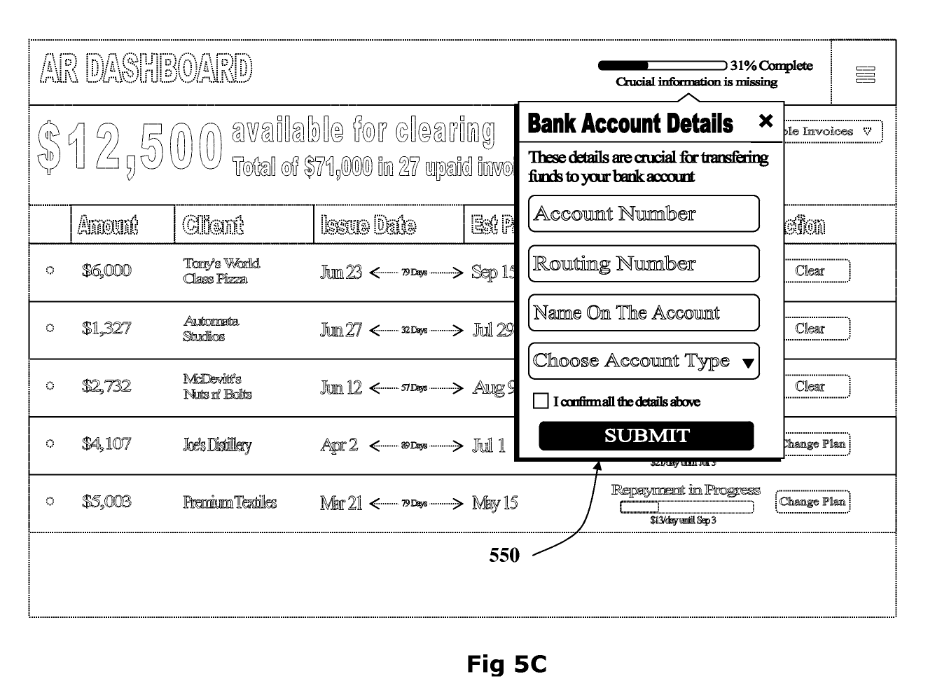

To illustrate the method for providing liquid funds to a business, reference is now made to FIGS. 4A-F and FIGS. 5A-C which schematically represent features of a possible registration process and AR invoice based dashboard 500 which may be presented to a business representative. It is to be understood that the example presented herein is provided in a non-limiting manner for illustrative purposes only. Other examples will occur to those skilled in the art.

FIG. 4A schematically represent possible introduction screens 400, 400′ which may be presented to a user by a funder to prompt them to register for a liquid fund provision service. FIG. 4A schematically represents possible introduction screens 400 of a browser based user interface. The introduction screen 400 including a registration panel 410. The registration panel 410 includes an identification box 412, a password input box 414, a password confirmation box 416, and a submission button 418.

A business representative may initiate registration by entering a user ID, such as an email, user name, ID number or the like in the identification box 412. It is noted that the password input box 414 and password confirmation 416 are presented on the introduction screen 400 itself thereby allowing the business representative to set and confirm a password the first time that they interact with the system. The initial registration information may be submitted by activating the submission button 418.

FIG. 4B represents a possible screen that may be presented to a business representative once the initial registration information has been submitted. The business represented is here prompted to provide the funder with access to digital data pertaining to business interactions of the business. A selection box 420 may be presented via which the user may select a business management application that they use to manage business interaction, such as a financial management application or the like. As illustrated in FIG. 4C, a drop-down list 430, for example, may be displayed to the business representative via which they may select at least one financial management service used by the business and to which the funder is to be granted access. Once the selection is made a connect button 440 (FIG. 4D) is activated via which the user may connect the third party software associated with the selected financial management service to the funder server.

Referring to FIG. 4E, the software associated with the selected financial management service may open a window 450 including an identification box 452 via which user may input a user ID, and a password box 454 via which the user may enter a password and a button 456 via which the user may grant permission to the funder server to access digital data from the database associated with the selected financial management service.

With particular reference to FIGS. 5A-C which schematically represent features of a possible AR invoice based dashboard 500 which may be presented to a business representative who has successfully completed registration.

Referring now to FIG. 5A, the dashboard may include a credit availability panel 510 and an AR invoice list panel 520. The credit availability panel may provide an indication of the total credit available to the business from the funder 512, alongside the total amount of funds due to the business 514 from all the AR invoices in the list. Accordingly, the business representative may see at a glance the status of the line of credit available from the funder.

The AR invoice list panel 520 may present a table each row 521 of which represents a different AR invoice and indicates, for the AR invoice, the amount due to be paid to the business 522, the business client to whom the invoice was issued 523, the issue date 524, the estimated payment date 525, and the availability status of the loan 526.

The list of AR invoices may be created using financial data gathered by the funder server from the financial management database. Accordingly, the list may be automatically adjusted in an ongoing fashion as the business uses its financial management software and the database is updated.

It is noted that not all AR invoices may be available for clearing, reasons for an AR invoice not being available include, for example: the AR invoice may be have already been used to underwrite provision of liquid funds, the amount due on AR invoice may exceed a the maximum funds which are permitted to be underwritten by a single invoice, the amount due on the AR invoice may exceed the total credit available to the business from the funder, the business client to whom the invoice was issued may be deemed too high a risk, and the like.

According to one embodiment, the system may further include automated digital invoice-fraud detection. The dashboard may be able to determine whether a digital invoice is fraudulent (e.g. was entered just to make the books look better at the end of year, or just to obtain invoice financing from us or others) based on financial data and secondary data. Specific invoice information may be matched with patterns reconstructed from other invoices that have been determined as non-fraudulent. A determination may be made whether an examined invoice matches the non-fraudulent patterns. For example, if a business shows a pattern of consistently emailing invoices to customers on Monday and 90% these invoices are authorized within 2-3 days, then an invoice for a new customer that was sent on a Tuesday, but through regular mail (e.g. printed, not emailed), the invoice may be identified as a likely candidate of a fraudulent invoice.

When liquid funds have been taken for a particular AR invoice, an indication may be provided 527 to show the repayment status of the associated loan, for example indicating the payment schedule, the extent to which the loan has been repaid, and the amount still outstanding on the loan. Such an indication may be represented in a textual format or as a graphical representation such as a status bar, a needle indicator or the like.

Each row of the AR invoice may further include an action button 530. The functionality of the action button may be determined by the availability status of the associated AR invoice. For example, where an AR invoice is available, the button may initiate a request mechanism such as described herein, whereas if liquid funds have already been provided for the AR invoice, the button may provide a mechanism for adjusting payment plan, again, where the loan is not available the button may be disabled.

Referring now to FIG. 5B, a request mechanism panel 540 is represented which may be initiated via the action button associated with an AR invoice. The request mechanism may present a proposed payment schedule including for example, details such as the amount of money to be provided by the loan, the total amount to be repaid, the clearing fee, the frequency and value of repayment installments and the final due date for repayment. The request mechanism further includes a confirmation button via which a business representative may approve the loan conditions and repayment schedule and initiate a confirmation mechanism.

It is noted that the payment schedule may be editable, for example by clicking on a number and amending it as required.

It is a feature of the current disclosure that, although a payment schedule is defined upon approval of the loan, the payment schedule may be adjusted at a later date, for example to change frequency or amount of repayment installments, to extend the length of loan or to repay a loan or other provided liquid funds early. Indeed early repayment may be rewarded by a reduced clearing fee. Thus for example a business may clear liquid funds associated with an AR invoice as soon as the AR invoice has been settled by the client, even if the invoice is settled earlier than the estimated payment date.

In one embodiment, tailoring of repayment plans may be automated. Using data from both financial and secondary sources, a repayment plan may be tailor-fitted at any given point in time to ensure timely loan payments. The repayment plan for the same invoice can be different if it is generated today, tomorrow, in a week, etc., depending on new data that is accumulated, and a delta (change) in time (due to elements considered like business cyclicality, holidays, etc.).

An automated, on-the-fly repayment plan modification may also be provided. On any given repayment plan, before an actual debit, the probability of a sufficient money balance of the business bank account to debit can be calculated (e.g., based on financial data and/or secondary data associated with the business). If the chances are lower than, e.g., 5%, a debit may be rescheduled to another point in time (such as the end of the current repayment plan). A benefit of the repayment plan modification includes saving the costs of high banking fees associated with failed payments.

Referring now to FIG. 5C a confirmation mechanism 550 is presented via which a business user may confirm the request of the loan and enter bank details. The confirmation mechanism may be initiated by the confirmation button of the request mechanism.

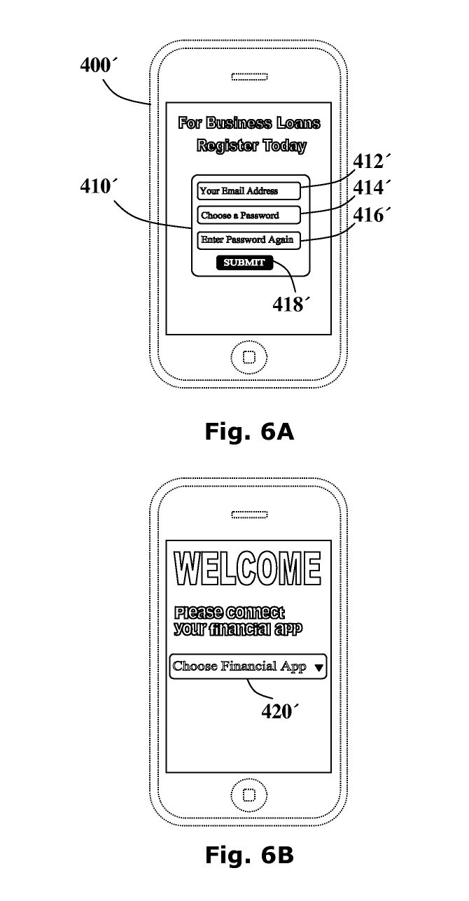

Although FIGS. 4A-F and 5A-C represents a browser based user interface, other platforms are available for registering for the service and presenting a dashboard. For the sake of illustration, FIG. 6A shows another embodiment including an introduction screen 400′ which may be presented by an application program, or app, running on a mobile phone, smart phone, tablet computer or the like. The software application may include a registration box 410′ including an identification box 412′, a password input box 414′, a password confirmation box 416′, and a submission button 418′. FIG. 6B shows a corresponding selection box 420′ screen which may be presented once initial registration is submitted using the application program running on a mobile phone.

FIGS. 1 through 6B are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

1. A distributed system of computerized devices connected over a communication network, the distributed system being useable to provide liquid funds to an entity, the distributed system comprising:
one or more computerized terminals connected to the communication network and programmed to send over the communication network registration data and one or more requests for liquid funds computed as a function of an amount charged on an accounts receivable invoice issued by the entity;
a computerized storage facility accessible over the communication network and storing an entity management database used by the entity and containing first digital data related to transactions of the entity; and
a funder server connected to the communication network and programmed to receive the registration data and the one or more requests for liquid funds from the one or more computerized terminals, to verify the registration data, to retrieve the first digital data from the entity management database based on the verified registration data, to assess at least one selected from the group consisting of a credit worthiness of the entity and a rating of the accounts receivable invoice based at least in part on the first digital data, to determine whether to generate and transmit an electronic instruction to transfer to the entity some or all of the liquid funds identified in the one or more requests, and, based on such determination, to transmit the electronic instruction to a funder computing system connected over the communication network.

2. The system of claim 1, wherein the communication network is the Internet.

3. The system of claim 1, wherein the one or more computerized terminals comprise at least one selected from the group consisting of: desktop computers, laptop computers, mobile phones, and tablet computers.

4. The system of claim 1, wherein the entity management database comprises at least one of the group consisting of: financial management software, accounting software, invoicing software, Customer Relationship Management (CRM), payroll software, project management software, HR management software, time-tracking software, and combinations thereof.

5. The system of claim 1, wherein the one or more computerized terminals is programmed to generate a user interface displaying an accounts receivable invoice based dashboard from which a user may designate the accounts receivable invoice upon which the request for liquid funds is based.

6. The system of claim 5, wherein the user interface provides a request facility whereby the user may select the accounts receivable invoice and generate the request for liquid funds based on the selected accounts receivable invoice.

7. The system of claim 1, further comprising a memory device in or accessible to the funder server storing second digital data pertaining to the entity obtained from at least one secondary source accessible over the communication network.

8. The system of claim 7, wherein the secondary source comprises at least one of a group consisting of: social networks, computerized public records, computerized government records, computerized legal records, computerized newspaper archives, computerized data aggregators, and combinations thereof.

9. In a system comprising at least one funder server in communication with a communication network, said communication network being connected to at least one computerized terminal, a first storage device storing an entity management database storing first digital data pertaining to transactions of an entity, and a second storage device not managed by said entity and storing second digital data pertaining to said entity, a method of operating said funder server to provide liquid funds to the entity in an improved manner, the method comprising:
receiving over the communication network from said computerized terminal a request for liquid funds a registration data identifying said entity;
accessing said first storage device over said communication network and retrieving said first digital data from said entity management database based on said registration data;
accessing said second storage device over said communication network and retrieving said second digital data based on said registration data;
computing a credit rating value of the entity based at least in part on said first or second digital data by automatically identifying risk indicators in the first or second digital data, applying a weighting coefficient to each risk indicator, and applying a credit rating function to said weighted risk indicators to compute the credit rating value; and
automatically determining whether to authorize transfer of the requested liquid funds to the entity based at least in part on said credit rating value.

10. The method of claim 9, wherein the funder server compute the credit rating value using the following credit rating function:
$$R = {K}_{f} \frac{\sum {W}_{i} {F}_{i}}{{N}_{f}} + {K}_{s} \frac{\sum {W}_{j} {S}_{j}}{{N}_{s}}$$
where R represents the credit rating value to be computed, Fi represents a risk indicator identified in the first digital data, Wi represents the weighting coefficient of Fi, Nf represents the number of risk indicators identified in the first digital data, Kf represents a weighting factor for the risk contribution from the first digital data, Fj represents a risk indicator identified in second digital data, Wj represents the weighting coefficient of Fj, Ns represents the number of risk indicators identified in the second digital data, and Ks represents a weighting factor for the risk contribution from the secondary data.

11. A computerized method for providing liquid funds to a business comprising:
said business issuing an accounts receivable (AR) invoice to a client, said AR invoice requesting payment of a total amount charged;
said business registering with a funder for an automatically underwritten fund provision service;
said business requesting liquid funds from said funder, said liquid funds having a value determined by the total amount charged on said AR invoice; and
said business receiving requested liquid funds from said funder.

12. The method of claim 11 wherein the step of said business requesting liquid funds from a funder comprises:
said business accessing an AR invoice based dashboard;
said business selecting at least one AR invoice from a list presented by said dashboard; and
said business requesting clearance of selected AR invoice.

13. The method of claim 11 further comprising:
said business repaying said requested liquid funds according to an agreed payment schedule.

14. The method of claim 11 further comprising:
said business providing said funder with access to digital data from business management software; and
said business receiving at least one credit limit determined by said digital data.

15. The method of claim 14 wherein said business management software comprises at least one of the group consisting of: financial management software, accounting software, invoicing software, Customer Relationship Management (CRM), payroll software and combinations thereof.

16. The method of claim 14 wherein said at least one credit limit is selected from at least one of the group consisting of:
a maximum total funds available to the business from the funder;
a maximum value of total amount charged on a single AR invoice which is available to the business from the funder; and
a maximum value of funds owed to said business by a single client which are available to the business from the funder.

17. The method of claim 11 further comprising:
said funder obtaining secondary digital data pertaining to said business from at least one secondary source.

18. The method of claim 17 wherein said secondary digital data comprises data pertaining to the quality of the clients of said business.

19. The method of claim 17 wherein said secondary source comprises at least one of a group consisting of: social networks, public records, government records, legal records, newspaper archives, data aggregators and combinations thereof.

20. The method of claim 11 further comprising said business accessing an AR invoice based dashboard.

21. The method of claim 20 wherein said AR invoice based dashboard presents a list of AR invoices issued by said business.

22. The method of claim 21 wherein said list of AR invoices is generated from digital data accessed from business management software.

23. The method of claim 21 wherein AR invoice based dashboard presents, for each AR invoice, at least one characteristic selected from: amount charged, issue date, estimated payment date, availability status and combinations thereof.

24. The method of claim 20 wherein said AR invoice based dashboard provides information relating to credit available to said business.

25. The method of claim 20 wherein said dashboard provides a request facility whereby said business may select at least one AR invoice and request liquid funds having value determined by the amount charged on selected AR invoice.

26. A computer implemented method for providing liquid funds to a business comprising at least one processor executing instructions to perform the following operations:
receiving a request from said business for liquid funds having a value determined by the total amount charged on an accounts receivable (AR) invoice issued to a client by said business;
assessing credit worthiness of the business; and
authorizing transfer of requested funds to the business.

27. The method of claim 26 wherein the operation of receiving a request from said business comprises:
presenting an AR invoice based dashboard to said business;
receiving a request for clearance of at least one AR invoice selected by the business from a list presented by said dashboard.

28. The method of claim 27 wherein the operation of receiving a request from said business further comprises:
suggesting a payment schedule to said business for the repayment of requested liquid funds.

29. The method of claim 28 wherein the operation of receiving a request from said business further comprises:
receiving an edited suggested payment schedule for the repayment of said requested liquid funds; and
approving said edited suggested payment schedule.

30. The method of claim 26 wherein the operation of assessing credit worthiness of the business comprises:
accessing digital data from a business management software used by said business; and
setting at least one credit limit determined by said digital data.

31. The method of claim 26 wherein said at least one credit limit is selected from at least one of the group consisting of:
a maximum total funds available to the business from the funder;
a maximum value of total amount charged on a single AR invoice which is available to the business from the funder; and
a maximum value of funds owed to said business by a single client which are available to the business from the funder.

32. The method of claim 26 wherein the operation of assessing credit worthiness of the business comprises:
obtaining secondary digital data pertaining to the quality of the business's clients from at least one secondary source.

33. A computer implemented method for providing a credit rating for a business, said method comprising at least one processor executing instructions to perform the following operations:
determining a credit rating function;
obtaining access to digital data from a business management software used by said business;
identifying at least one risk indicator from said digital data;
using said at least one risk indicator as an argument of said credit rating function; and
applying said credit rating function thereby generating a credit rating for said business.

34. The method of claim 33 wherein said business management software comprises at least one of the group consisting of: financial management software, accounting software, invoicing software, Customer Relationship Management (CRM), payroll software and combinations thereof.

35. The method of claim 33, further comprising said at least one processor executing instructions to perform the additional operations:
obtaining secondary digital data pertaining to the business from secondary sources;
identifying at least one secondary risk indicator from the digital data; and
using said at least one secondary risk indicator as an argument for said credit rating function.

36. The method of claim 33 wherein said credit rating function comprises at least one monomial factor comprising the product of at least one risk indicator parameter and a weighting coefficient.

37. A system for providing liquid funds to a business comprising at least one funder server in communication with a communication network, said communication network comprising at least one business terminal, and at least one business management database storing digital data pertaining to business interactions of said business, wherein said funder server is operable to:
receive from said business terminal requests for liquid funds;
access said business management database and to obtain said digital data;
assess credit worthiness of the business according to said digital data; and
authorize transfer of requested funds to the business.

38. The system of claim 37 wherein said communication network further comprises at least one secondary data source and said funder server is further operable to access said at least one secondary source and to obtain said secondary data pertaining to the business.

39. The system of claim 37 wherein said funder server comprises at least one processor operable to execute instructions to perform the following operations:
determining a credit rating function;
identifying at least one risk indicator from said digital data;
using said at least one risk indicator as an argument of said credit rating function; and
applying said credit rating function thereby generating at least one credit rating for said business.
